(19) United States
(12) Patent Application Publication
(10) Pub. No.: US 2017/0265525 A1
(43) Pub. Date: Sep. 21, 2017

(54) ELECTRONIC CIGARETTE AND SMOKING METHOD THEREOF

(71) Applicant: Shenzhen First Union Technology Co., Ltd., Shenzhen City (CN)

(72) Inventors: YONGHAI LI, Shenzhen City (CN); ZHONGLI XU, Shenzhen City (CN); SHUYUN HU, Shenzhen City (CN)

(21) Appl. No.: 15/605,940

(22) Filed: May 25, 2017

(30) Foreign Application Priority Data
May 27, 2016 (CN) 201610358924.8

(51) Int. Cl. A24F 47/00; H05B 1/02

(52) U.S. Cl. CPC A24F 47/008; H05B 1/0244

(57) ABSTRACT

An electronic cigarette includes a housing, a controller in the housing, an input module connected to the controller, a storage module connected to the controller, and a heating body connected to the controller. The input module is configured for inputting a type of tobacco liquid, and sending an input signal to the controller. The storage module is configured for storing a plurality of types of tobacco liquid and a plurality of temperature curves corresponding to the plurality of types of tobacco liquid. The heating body is configured for heating the tobacco liquid to form aerosol. The controller is configured for acquiring a temperature curve corresponding to the tobacco liquid based on the input signal of the input module, and controlling the heating body to heat the tobacco liquid according to the temperature curve.

### TECHNICAL FIELD

The present invention relates to electronic cigarettes, and particularly to an electronic cigarette and a smoking method using same.

### BACKGROUND ART

A typical electronic cigarette heats tobacco liquid according to a constant preset temperature curve despite of different types of tobacco liquid. However, different types of tobacco liquid may have different characteristics, e.g., boiling point. Accordingly, the temperature curve may not be suitable for all these types of tobacco liquid, thus rendering user unsatisfactory.

What are needed, therefore, are an electronic cigarette, and a smoking method of the electronic cigarette, which can overcome the above shortcomings.

### SUMMARY

An electronic cigarette includes a housing, a controller in the housing, an input module connected to the controller, a storage module connected to the controller, and a heating body connected to the controller. The input module is configured for inputting a type of tobacco liquid, and sending an input signal to the controller. The storage module is configured for storing a plurality of types of tobacco liquid and a plurality of temperature curves corresponding to the plurality of types of tobacco liquid. The heating body is configured for heating the tobacco liquid to form aerosol. The controller is configured for acquiring a temperature curve corresponding to the tobacco liquid based on the input signal of the input module, and controlling the heating body to heat the tobacco liquid according to the temperature curve.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a front view of an electronic cigarette according to an exemplary embodiment.

FIG. 2 is a functional block diagram of the electronic cigarette of FIG. 1.

FIG. 3 is a schematic temperature curve of one type of tobacco liquid.

FIG. 4 is a flow chart of smoking method using the electronic cigarette of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

Several definitions that apply throughout this disclosure will now be presented.

The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

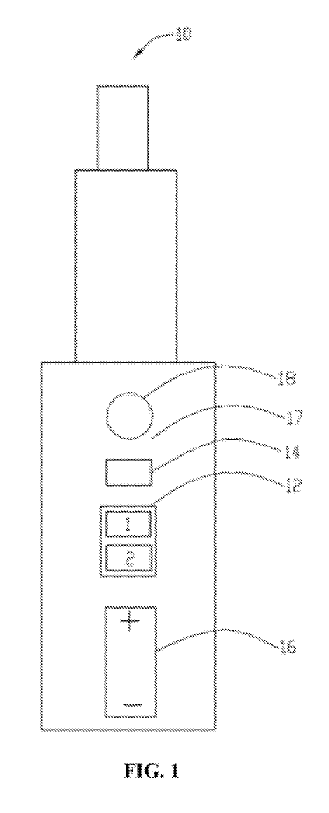

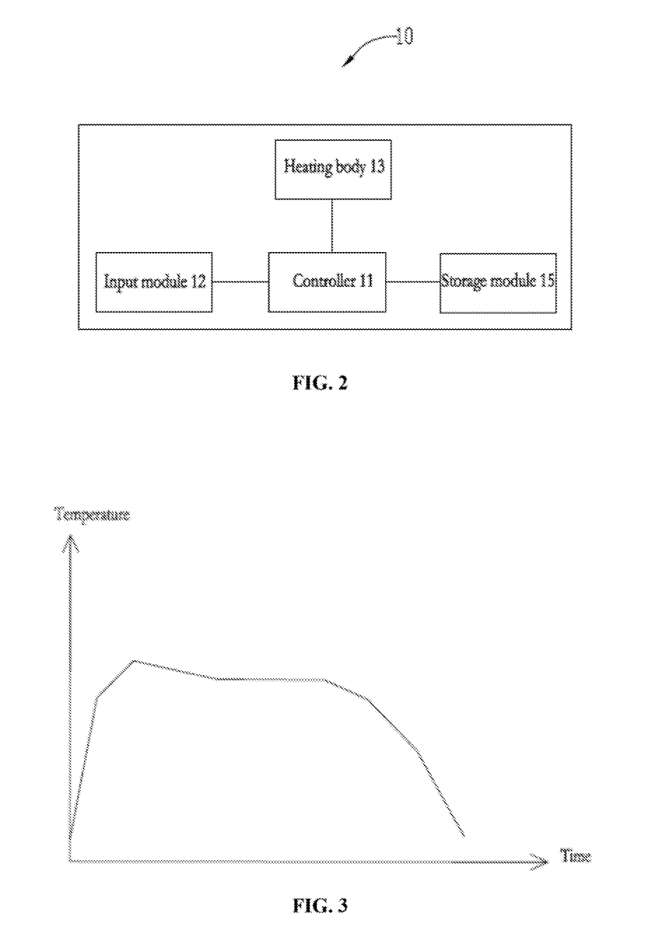

Referring to FIGS. 1-2, an electronic cigarette 10 includes a housing 17, a controller 11, an input module 12, a storage module 15, a heating body 13. The controller 11, the input module 12, the storage module 15, and the heating body 13 are received in the housing 17. The input module 12, the storage module 15, and the heating body 13 are all connected to the controller 11. The input module 12 is configured (i.e., structured and arranged) for inputting a type of tobacco liquid, and sending an input signal to the controller 11. The input module 12 includes a plurality of buttons. For example, button 1 represents tobacco liquid number 1; button 2 represents tobacco liquid number 2. The storage module 15 is configured for storing types of tobacco liquid, and temperature curves corresponding to each type of tobacco liquid. The heating body 13 is configured for heating tobacco liquid in the electronic cigarette 10 to form aerosol. The heating body 13 may be a heating wire or a heating plate. The electronic cigarette 10 includes a power switch 18 arranged on the housing 17.

The electronic cigarette 10 further includes a storage button 14. When the electronic cigarette 10 works and the storage button 14 is pressed, the storage module 15 records a new temperature curve corresponding to the present tobacco liquid.

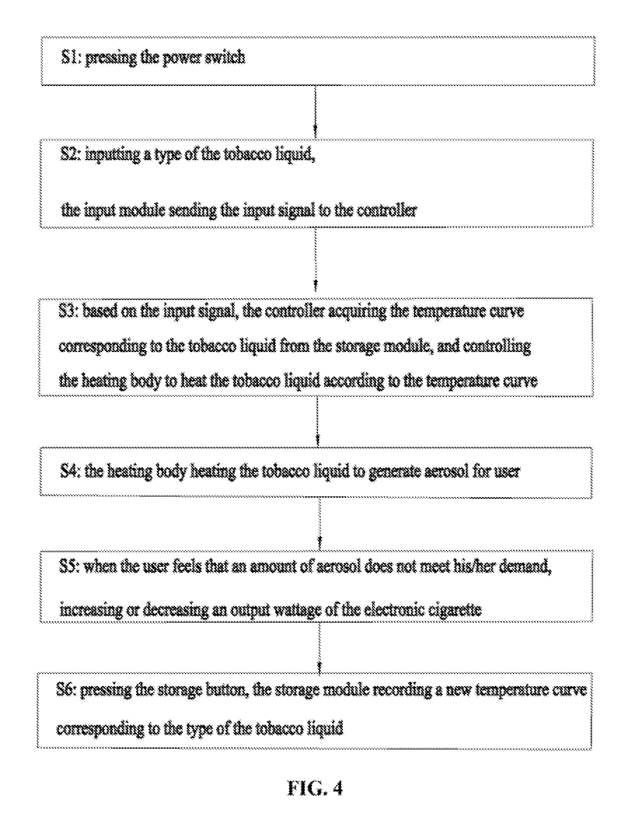

The electronic cigarette 10 further includes a power adjusting button 16. The power adjusting button 16 is configured for increasing or decreasing an output wattage of the electronic cigarette 10, so that the temperature curve can be manually adjusted, thus adjusting an amount of aerosol generated. The temperature curve is a curve, which shows a temperature of the heating body 13, which varies as time passes under control of the controller 13. FIG. 3 shows an exemplary temperature curve of one type of tobacco liquid stored in the storage module 15. The temperature control may be achieved by a Proportion-Integral-Derivative (PID) controller.

Referring to FIG. 4, a smoking method using the electronic cigarette 10 includes the following steps.

In step S1, the power switch is pressed.

In step S2, a type of tobacco liquid is input by the user, and the input module sends the input signal to the controller. For example, when the user uses the number 1 tobacco liquid, the button 1 should be pressed.

In step S3, based on the input signal of the input module, the controller acquires the temperature curve corresponding to the tobacco liquid, and controls the heating body to heat the tobacco liquid according to the temperature curve.

In step S4, the tobacco liquid is heated by the heating body to generate aerosol for user.

In step S5, if an amount of aerosol does not meet the demand of the user, the user can increase or decrease the output wattage of the electronic cigarette. When the user feels that the amount of aerosol is too small, the user can increase the output wattage of the electronic cigarette. When the user feels that the amount of aerosol is too large, the user can decrease the output wattage of the electronic cigarette.

In step S6, when the user feels that the amount of aerosol is suitable, the user can press the storage button, so that the storage module records a new temperature curve. In this way, the new temperature curve replaces the previous temperature curve in the storage module.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An electronic cigarette, comprising:
a housing;
a controller in the housing;
an input module connected to the controller;
a storage module connected to the controller; and
a heating body connected to the controller;
wherein the input module is configured for inputting a type of tobacco liquid, and sending an input signal to the controller;
the storage module is configured for storing a plurality of types of tobacco liquid and a plurality of temperature curves corresponding to the plurality of types of tobacco liquid;
the heating body is configured for heating the tobacco liquid to form aerosol; and
the controller is configured for acquiring a temperature curve corresponding to the tobacco liquid based on the input signal of the input module, and controlling the heating body to heat the tobacco liquid according to the temperature curve.

2. The electronic cigarette according to claim 1, further comprising a power adjusting button, wherein the power adjusting button is configured for increasing or decreasing an output wattage of the electronic cigarette, thus manually adjusting the temperature curve.

3. The electronic cigarette according to claim 2, further comprising a storage button arranged on the housing, wherein when the electronic cigarette works and the storage button is pressed, the storage module records a new temperature curve corresponding to the tobacco liquid.

4. The electronic cigarette according to claim 1, wherein the input module comprises a plurality of buttons arranged on the housing.

5. The electronic cigarette according to claim 1, wherein the controller comprises a PID controller.

6. The electronic cigarette according to claim 1, further comprising a power switch on the housing.

7. A smoking method of the electronic cigarette according to claim 1, comprising:
inputting a type of the tobacco liquid, the input module sending the input signal to the controller;
based on the input signal, the controller acquiring the temperature curve corresponding to the tobacco liquid from the storage module, and controlling the heating body to heat the tobacco liquid according to the temperature curve; and
the heating body heating the tobacco liquid to generate aerosol for user.

8. The smoking method of claim 7, further comprising: increasing or decreasing an output wattage of the electronic cigarette, thus manually adjusting the temperature curve.

9. The smoking method of claim 8, further comprising:
the storage module recording a temperature curve corresponding to the type of the tobacco liquid.
